(19) United States
(12) Patent Application Publication
(10) Pub. No.: US 2025/0292117 A1
(43) Pub. Date: Sep. 18, 2025

(54) TECHNIQUES FOR VALIDATING DECISION TABLES

(71) Applicant: Red Hat, Inc., Raleigh, NC (US)

(72) Inventor: Toni Allan Rikkola, Helsinki (FI)

(21) Appl. No.: 18/608,657

(22) Filed: Mar. 18, 2024

(51) Int. Cl. G06N 5/025

(52) U.S. Cl. CPC G06N 5/025

(57) ABSTRACT

Systems and methods are disclosed for validating decision tables. An example method includes comparing a new version of a decision table with a previous version of the decision table to identify a changed rule among a plurality of rules of the decision table. The method also includes pruning, by a processing device, an initial list of rules to be validated in view of the changed rule to generate a reduced list of rules based on a variant map that describes differences between the plurality of rules in the previous version of the decision table. The method also includes performing a validation process for the reduced list of rules.

### TECHNICAL FIELD

Aspects of the present disclosure relate to rules engines, and more particularly, to techniques for validating a decision table describing a rule base for a rules engine.

### BACKGROUND

A rules engine is a software system that executes rules with respect to facts of a computer system stored in the computer system's working memory. A rule is a small piece of code of the form of “when <condition> then <consequence>.” The <condition> is a declarative constraint over part of the working memory, and the <consequence> is a snippet of executable code, written in some programming language. Rules engines are used in a variety of applications to apply the given rules to data to produce outcomes. For example, rules engines may be used in business process management, software management systems, decision support systems, event-driven architectures, serverless computing logic, and other applications. Various techniques exist for defining the rules to be executed by a rules engine. In some cases, rules may be defined through the use of one or more decision tables, which provide a concise visual representation for specifying which actions to perform depending on given conditions.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram of an example computing system in accordance with some embodiments of the present disclosure.

FIG. 2 is a block diagram that illustrates an example decision table in accordance with some embodiments of the present disclosure.

FIG. 3 is a process flow diagram of a method for validating a decision table, in accordance with some embodiments of the present disclosure.

FIG. 4 is a process flow diagram of summarizing a method for validating a decision table, in accordance with some embodiments of the present disclosure.

FIG. 5 is a block diagram of a system for validating a decision table, in accordance with some embodiments of the present disclosure.

FIG. 6 illustrates a diagrammatic representation of a machine in the example form of a computer system within which a set of instructions, for causing the machine to perform any one or more of the methodologies discussed herein.

### DETAILED DESCRIPTION

A rules engine is a software system that executes one or more rules in a runtime environment. The present techniques can be implemented in various types of rules engines, including business rules engines and others. A rules engine works by applying a set of rules to facts, which are input to the working memory of the rules engine. Evaluation of the facts according to the rules yields a set of one or more actions. Rules engines may be used in a variety of contexts to apply the given rules to data to produce outcomes. Rules engines may be included as one component of larger systems, such as software management systems, serverless computing, business process management, automation, and many others.

The set of rules applied by a rules engine may be referred to as a rule base. In some cases, the rule base may be generated and/or represented using a decision table. Decision tables are a concise visual representation of the rules that specifying the output to be activated depending on a set of conditions specified in one or more input fields. Each output may describe data to be provided or an operation to be performed if the input to the decision table satisfies the conditions applied for the corresponding rule. The decision table may be compiled automatically (i.e., without human interaction) into the rule base for the rules engine.

A variety of problems can arise with traditional decision tables. For example, if two rules are in conflict, both rules could be true for the same set of inputs, possibly resulting in conflicting outputs for the same set of inputs. As a decision table accumulate more rules over time, the decision tables may eventually become so large that they can become difficult to manage and troubleshoot for such inconsistencies. Accordingly, before deploying the decision table, the decision table may be processed by a verification algorithm that evaluates the rules to identify conflicts such as overlapping rules, subsumed rules, redundant rules, and other errors. Depending on the size of the decision table, the verification process may take several minutes to complete.

Embodiments of the present disclosure provide an improved verification process that is able to validate a decision table much more quickly and efficiently. For any input field of it will generally be the case that the conditional expressions specified for some rules will vary while other may be identical. If the conditional expressions are identical within a set of rules, then any of these rules may be activated depending on the conditional expressions contained in the other input fields. When the conditional expressions are identical within the same input field of a set of rules, this may be referred to as a node. If the conditional expressions vary between any two sets of rules (and do not overlap), then only one of these sets of rules can be activated since the input can only satisfy the conditions of one of these sets of rules. When the conditional expression for one rule varies from the conditional expression within the same input field of another rule, this may be referred to herein as a “variant.”

In accordance with embodiments of the present techniques, validation process includes generating a map of variants identified within the decision tables. This map may be stored and used to improve the speed and efficiency for subsequent executions of the validation process for a new version of the decision table. If a previous map of variants has been stored, the map may be used to eliminate some rules from the scope of the validation process. For example, if a rule in the decision table has changed from a previous validated version of the decision table, each input field of the new rule can be compared to its previous version to determine whether the input field for that rule has changed. If the input field has not changed, that means it is still part of the same node and that the same variants are still valid for the new rule. Accordingly, the previous map of variants can be used to identify the variants and eliminate them from the scope of the validation process. This process may be repeated for each input field of the decision table to reduce the set of rules that will be included in the scope of the validation process. In this way, the number of rules that go through the validation process can be reduced, resulting in a faster validation that consumes fewer processing resources. In some cases, the validation process may be reduced from several minutes to a few second or even less than a second.

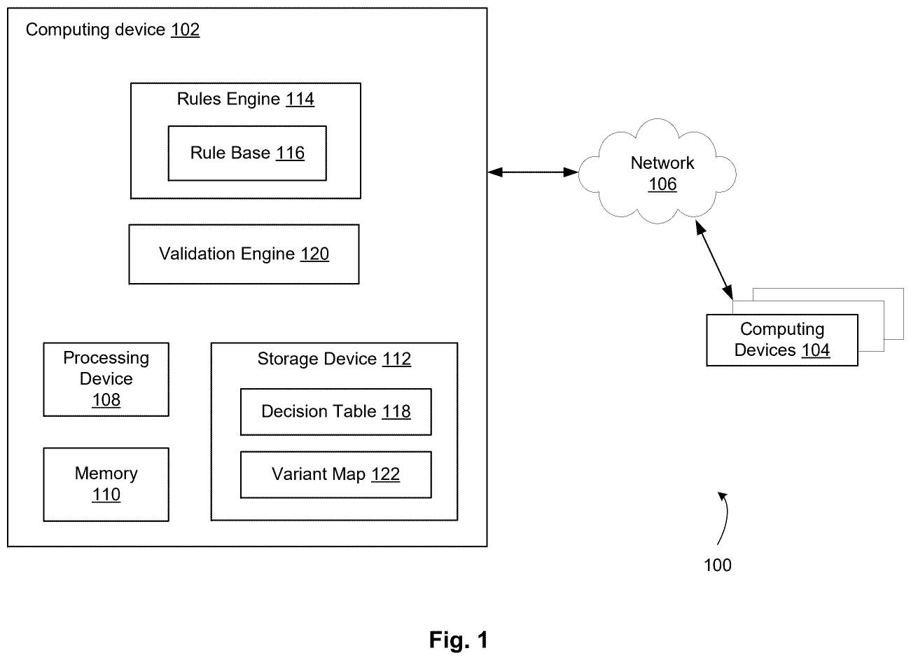

FIG. 1 is a block diagram of an example computing system 100 in accordance with some embodiments of the present disclosure. One skilled in the art will appreciate that other architectures are possible for system 100 and any components thereof, and that the implementation of a system utilizing examples of the invention are not necessarily limited to the specific architecture depicted by FIG. 1. The system 100 may be a cloud-based infrastructure or non-cloud-based system such as a personal computer, one or more servers communicatively coupled through a network, and other configurations. The system 100 may include a computing device 102 and computing devices 104, which may be coupled to each other (e.g., may be operatively coupled, communicatively coupled, may communicate data/messages with each other) via network 106.

The computing device 102 can include one or more processing devices 108 (e.g., central processing units (CPUs), graphical processing units (GPUs), etc.), main memory 110 which may include volatile memory devices (e.g., random access memory (RAM)), non-volatile memory devices (e.g., flash memory) and/or other types of memory devices, and a storage device 112 (e.g., one or more magnetic hard disk drives, a Peripheral Component Interconnect (PCI) solid state drive, a Redundant Array of Independent Disks (RAID) system, a network attached storage (NAS) array, etc.). In certain implementations, main memory 110 may be non-uniform access (NUMA), such that memory access time depends on the memory location relative to processing device 108. The storage device 112 may be a persistent storage and may be a local storage unit or a remote storage unit. Persistent storage may be a magnetic storage unit, optical storage unit, solid state storage unit, electronic storage units (main memory), or similar storage unit. Persistent storage may also be a monolithic/single device or a distributed set of devices. The storage device 112 may be configured for long-term storage of data and may retain data between power on/off cycles of the computing device 102. It should be noted that although, for simplicity, a single processing device 108, main memory 110, storage device 112, are shown, other embodiments may include a plurality of processing devices, memories, storage devices, and devices. Additionally, the computing device 102 may have additional components not shown in FIG. 1. Computing devices 104 may comprise similar architectures.

Network 106 may be a public network (e.g., the internet), a private network (e.g., a local area network (LAN) or wide area network (WAN)), or a combination thereof. In one embodiment, network 106 may include a wired or a wireless infrastructure, which may be provided by one or more wireless communications systems, such as a WiFi™ hotspot connected with the network 106 and/or a wireless carrier system that can be implemented using various data processing equipment, communication towers (e.g. cell towers), etc. In some embodiments, the network 106 may be an L3 network. The network 106 may carry communications (e.g., data, message, packets, frames, etc.) between computing devices 102 104.

The computing device 102 may include a rules engine 114. In some embodiments, each rule may be a small piece of code of the form when <condition> then <consequence>. The <condition> may be a constraint over part of the working memory. The <consequence> may be a snippet of executable code, written in some programming language. In one embodiment, the collection of the rules in a rule engine 114 forms a rule base 116, and the term “firing” may be used to describe evaluating all the rules in the rule base 116 over all the facts that are stored in the working memory; that is checking the condition over the facts contained in the working memory, and then executing the code of the consequence.

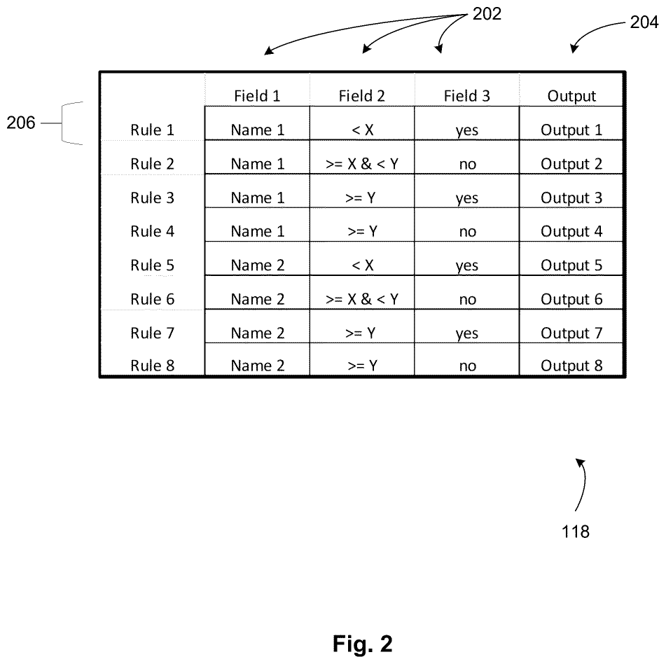

The computing device 102 may also include a decision table, which is used to define the rules of the rule base 116. The decision table 118 may be in the form of a spreadsheet that can be accessed by users (e.g., from computing devices 104) to create and/or edit a rule base 116. The decision table 118 may be accessed using a decision manager platform (e.g., Red Hat® Decision Manager), a spreadsheet editor, and other suitable software applications. The rules may be written according to any suitable format, such as Decision Model Notation (DMN), Drools source code (DRL). The decision table 118 may be stored as an Excel spreadsheet (XLS), Extensible Markup Language (XML) file, or JavaScript Object Notation (JSON) file, among others. The decision table 118 can be processed automatically to convert the decision table 118 to a file that can be used as the rule base 116 (e.g., DMN file, DRL file, etc.). Additionally, although one decision table 118 is shown, an actual decision table file (e.g., DMN file) may include two or more decision tables 118, which may be linked together and compiled to form the rule base 116. An example decision table 118 is shown in FIG. 2.

The computing device 102 also includes a validation engine 120, which can be used to validate the decision table 118 prior to deployment in a rules engine 114. The validation engine 120 may perform a variety of tests for identifying errors within the decision table 118, such as overlapping rules, subsumed rules, redundant rules, unclosed ranges, and others. The execution of the validation engine 120 may result a list of errors, which may be stored and/or displayed to the user. The user may then correct any identified errors and rerun the validation engine 120. Once the validation engine 120 indicates that the decision table 118 is validated, the corresponding rule base 116 may be deployed.

In accordance with embodiments, the validation engine 120 may create and/or update a variant map 122 each time the validation process is executed for the decision table 118. The variant map 122 records the variants that exist within the decision table 118 for each rule of the decision table 118. Example variant maps are described further below and shown in Tables 1 and 2. When the validation engine 120 executes, the validation engine 120 can determine whether a variant map 122 exists for the decision table 118. If a variant map 122 already exists, the variant map can be used to limit the scope of the validation process to those rules that may be affected by changes to the decision table 118. In other words, based the changes the decision table 118, the variant map 122 can be used to quickly and efficiently identify rules that do not need to be revalidated.

FIG. 2 is a block diagram that illustrates an example decision table 118 in accordance with some embodiments of the present disclosure. As shown in FIG. 2, the decision table 118 includes three input fields 202, each of which is represented as a separate column of the decision table 118. The rightmost column of the decision table is the output field 204. Each row of the decision table represents a different rule 206. In some embodiments, each rule 206 may have a rule name or other rule identifier, which enables the rules 206 from different versions of the same decision table 118 to be compared.

Each input field 202 corresponds with a specific input that will be asserted against the rules engine 114 (FIG. 1) and contains the conditionals expressions that will determine which output is activated. In other words, the rule 206 that is determined to be true given the asserted inputs determines which output 204 is activated. Each input field 202 may be associated with a constraint that limits the type of data that can received for that field and determines how to evaluate the input against the conditional expression included in that field. In the example provided in FIG. 2, Field 1 is a character string that requires a matching input character string, Field 2 is a numerical range used to evaluate a numerical input, and Field 3 is a Boolean used to evaluate a Boolean input. Using this decision table 118, if the input at Field 1 is {“Name 2”}, the input at Field 2 is a number less than X, and the input at Field 3 is {yes}, then Rule 5 would be true and Output 5 would be activated. It will be appreciated that the decision table 118 shown FIG. 2 is one example, which is provided for the sake of illustrating the present techniques. An actual decision table in accordance embodiments may involve other types of constraints and any suitable number of rules 206, input fields 202, and output fields 204.

An example of a variant map 122 (FIG. 1) that may be generated for the decision table 118 is shown below in Table 1. To generate the variant map 122, each input field 202 may be assigned a priority. The variant map 122 may be a cross correlation table where each entry indicates the highest priority field where a variant exists between the two correlated rules. To generate the variant map shown in Table 1, Field 1 has the highest priority, Field 2 has the next highest priority, and Field 3 has the lowest priority. Given these priorities and comparing Rule 1 and Rule 6 of the decision table 118, the variant for these rules would be recorded as existing at Field 1. In a similar manner, the variant for Rule 1 and Rule 2 would be recorded as existing at Field 2, the variant for Rule 3 and Rule 4 would be recorded as existing at Field 3, etc.

TABLE 1
Example Variant Map with Highest Priority Assigned to Field 1

| | Rule | Rule | Rule | Rule | Rule | Rule | Rule | Rule |
|---|---|---|---|---|---|---|---|---|
| | 1 | 2 | 3 | 4 | 5 | 6 | 7 | 8 |
| Rule 1 | — | 2 | 2 | 2 | 1 | 1 | 1 | 1 |
| Rule 2 | 2 | — | 2 | 2 | 1 | 1 | 1 | 1 |
| Rule 3 | 2 | 2 | — | 3 | 1 | 1 | 1 | 1 |
| Rule 4 | 2 | 2 | 3 | — | 1 | 1 | 1 | 1 |
| Rule 5 | 1 | 1 | 1 | 1 | — | 2 | 2 | 2 |
| Rule 6 | 1 | 1 | 1 | 1 | 2 | — | 2 | 2 |
| Rule 7 | 1 | 1 | 1 | 1 | 2 | 2 | — | 3 |
| Rule 8 | 1 | 1 | 1 | 1 | 2 | 2 | 3 | — |

The variant map 122 may be generated by the validation engine 120 and used for a subsequent validation of a new version of the decision table 118. During the subsequent validation, the validation engine 120 can determine which rules 206 have changed by comparing the current decision table 118 with the previous version of the decision table 118. Each changed rule 206 will be validated against the other rules to ensure that the change does not introduce a conflict. However, rather than validating the changed rule against every other rule in the decision table 118, the variant map 122 from the prior validation can be used to prune the list of rules to be included in the validation process. In some embodiments, the list of rules is pruned based, in part, on which field 202 of the changed rule was altered. Starting from the highest priority field, a determination may be made as to whether the conditional expression in that field has changed. If the conditional expression has changed, then none of the other rules are pruned. However, if the entry has not changed, the recorded variants for that rule and field are still valid. Therefore, any other rules that indicate a variant on Field 1 with respect to the changed rule may be eliminated from the list of rules to be included in the validation process. The same process may be performed for each input field of the changed rule in order of priority.

For example, if the only change is at Field 3 of Rule 5 (e.g., changed from {yes} to {no}), it would be determined that the highest priority field (Field 1 in this example) has not changed. Therefore, any other rule having a variant on Field 1 with respect to Rule 5 can be eliminated from the validation process. As indicated by the variant map of Table 1, this includes Rules 1-4. Thus, Rules 1-4 are eliminated (e.g., pruned). Next, it can be determined that Field 2also hasn't changed. Therefore, any other rule having a variant on Field 2 with respect to Rule 5 can also be eliminated from the validation. As indicated by the variant map of Table 1, this includes Rules 6-8. Thus, Rules 6-8 are eliminated. In this case, all of the other rules 206 have been eliminated, because the pruning process has determined that the changed rule cannot conflict with any of the other rules due the differences between their fields. The rule pruning process may be repeated for each rule 206 in the decision table 118 that has changed relative to the previously validated version.

The variant map generated for the decision table 118 will vary depending on the priority assigned to the input fields. In some embodiments, the priority may be assigned in the order that they appear in the decision table 118, e.g., from left to right. However, this may not lead to the most efficient process for pruning rules from the validation process. In some embodiments, priorities may be assigned to the input fields based on the number of unique variants within each input field. In such embodiments, the input field with the most unique variants is assigned the highest priority, the input field with the next highest number of unique variants is assigned the next highest priority, and so on.

In the example decision table 118, Field 2 includes four unique variants, i.e., four different conditional expressions, which are repeated within different rules 206. By contrast, Field 1 and Field 3 each have two unique variants. Accordingly, Field 2 may be assigned the highest priority, Field 1 may be assigned the second highest priority, and Field 3 may be assigned the lowest priority. Assigning priorities in this way results in the variant map shown in Table 2.

TABLE 2
Example Variant Map with Highest Priority Assigned to Field 2

| | Rule | Rule | Rule | Rule | Rule | Rule | Rule | Rule |
|---|---|---|---|---|---|---|---|---|
| | 1 | 2 | 3 | 4 | 5 | 6 | 7 | 8 |
| Rule 1 | — | 2 | 2 | 2 | 1 | 2 | 2 | 2 |
| Rule 2 | 2 | — | 2 | 2 | 2 | 1 | 2 | 2 |
| Rule 3 | 2 | 2 | — | 3 | 2 | 2 | 1 | 1 |
| Rule 4 | 2 | 2 | 3 | — | 2 | 2 | 1 | 1 |
| Rule 5 | 1 | 2 | 2 | 2 | — | 2 | 2 | 2 |
| Rule 6 | 2 | 1 | 2 | 2 | 2 | — | 2 | 2 |
| Rule 7 | 2 | 2 | 1 | 1 | 2 | 2 | — | 3 |
| Rule 8 | 2 | 2 | 1 | 1 | 2 | 2 | 3 | — |

The variant map shown in Table 2 may be used by the validation engine 120 during a subsequent validation in the same manner described above. Following the same example as above (i.e., the only change in the decision table 118 is that Field 3 of Rule 5 has changed from {yes} to {no}), the validation engine 120 compares current Rule 5 to the prior Rule 5 and determines that the highest priority field (Field 2 in this example) has not changed. Therefore, any other rule having a variant on Field 2 with respect to Rule 5 can be eliminated from the validation process. As indicated by the variant map of Table 2, this includes Rules 2-8. Thus, Rules 2-8 are eliminated (e.g., pruned). In the previous example that used the variant map of Table 1, four rules were pruned in the first iteration. By contrast, using the variant map of Table 2, seven rules are eliminated in the first iteration. Accordingly, it can be seen by these examples that assigning higher priority to the input field with the highest number of unique variants enables the pruning algorithm to eliminate rules more quickly.

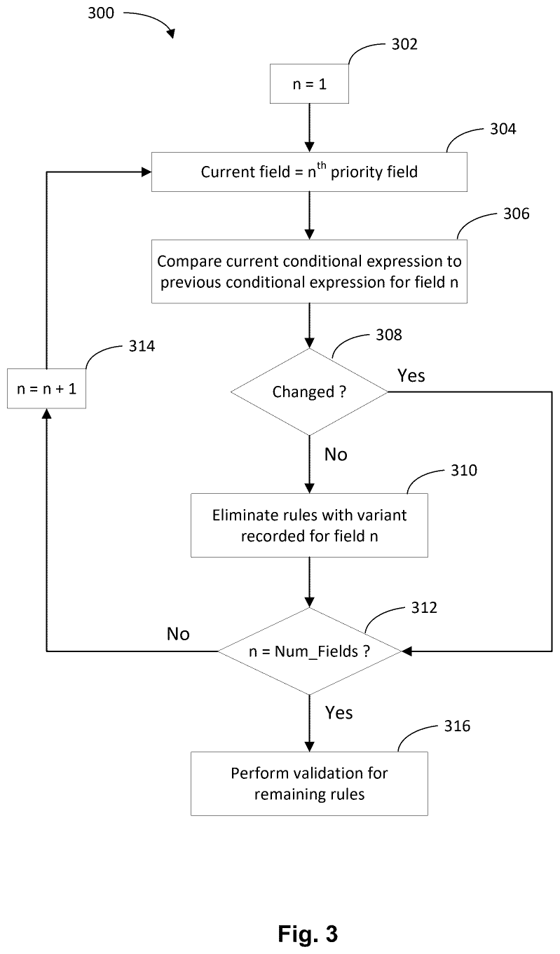

FIG. 3 is a process flow diagram of a method 300 for validating a decision table, in accordance with some embodiments of the present disclosure. The method 300 may be performed by processing logic that may include hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, at least a portion of method 300 may be performed by the validation engine 120 shown in FIG. 1.

With reference to FIG. 3, method 300 illustrates example functions used by various embodiments. Although specific function blocks (“blocks”) are disclosed in method 300, such blocks are examples. That is, embodiments are well suited to performing various other blocks or variations of the blocks recited in method 300. It is appreciated that the blocks in method 300 may be performed in an order different than presented, and that not all of the blocks in method 300 may be performed.

In the following description it is assumed that the decision table 118 (FIG. 1) has been previously validated and that the variant map 122 has been generated. When the validation process begins, the decision table may be processed to determine which rules have changed from the previous version of the decision table. Although not shown for the sake of clarity, the method 300 may be performed for each changed rule identified in the decision table. For purposes of the following description, the changed rule may be referred to the current rule. The method may begin at block 302.

At block 302, the index, n, is set to one, where n indicates which input field of the current rule is being processed. As shown in the example method 300, the input fields are processed in order of priority from the highest priority field to the lowest priority field.

At block 304, the current field is set to the input field with the nth priority. For example, if n equals one, the current field is set to the input field with the highest priority.

At block 306, the conditional expression in the current field is compared to the conditional expression contained in the same rule and field of the previous version of the decision table.

At block 308, a determination is made regarding whether the conditional expression has changed. If it has changed, no rules are pruned for the current field, and the process flow advances to block 312. If the conditional expression has not changed, the process flow advances to block 310.

At block 310, the variant map is processed to identify rules that have a variant recorded for field n relative to the current rule, and the identified rules are pruned, i.e., eliminated from the list of rules to be validated against the current rule.

At block 312, a determination is made regarding whether n is the last input field to be processed (i.e., whether n=Num_Fields). If n is not equal to the total number of input fields for the decision table, then the process continues to block 314.

At block 314, the index, n, is incremented by one, the process flow returns to block 304, and the process is repeated for the next highest priority field. If at block 314, n is equal to the total number of input fields (i.e., n=Num_Fields), then there are no more rules to be pruned, and the process advances to block 316.

At block 316, validation is performed using the remaining list of rules, which will include the current rule and any remaining rules from the decision table that have not been pruned. The results of the validation may be stored and/or displayed to the user. The process described above may be repeated for each changed rule. Additionally, changes to the decision table may be used to generate a new variant map, which may be used for a subsequent validation of the decision table.

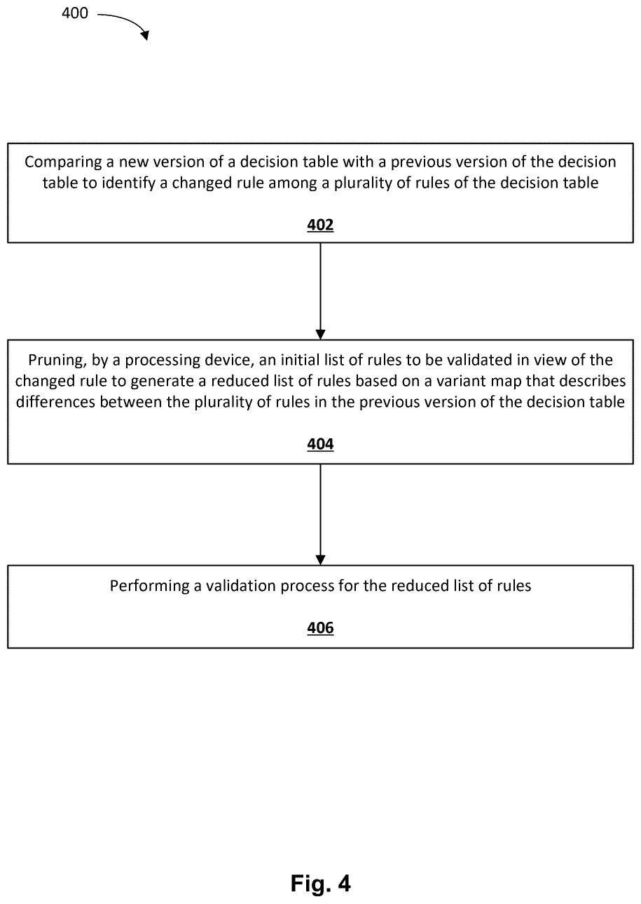

FIG. 4 is a process flow diagram of summarizing a method 400 for validating a decision table, in accordance with some embodiments of the present disclosure. Method 400 may be performed by processing logic that may include hardware, software, firmware, or a combination thereof. In some embodiments, at least a portion of method 400 may be performed by the validation engine 120 shown in FIG. 1.

With reference to FIG. 4, method 400 illustrates example functions used by various embodiments. Although specific function blocks (“blocks”) are disclosed in method 400, such blocks are examples. That is, embodiments are well suited to performing various other blocks or variations of the blocks recited in method 400. It is appreciated that the blocks in method 400 may be performed in an order different than presented, and that not all of the blocks in method 400 may be performed. The method 400 may begin at block 402.

At block 402, a new version of a decision table is compared with a previous version of the decision table to identify a changed rule among the plurality of rules. Any changed rules may introduce a conflict and may need to be revalidated against the other rules in the decision table. In some embodiments, each of the rules is associated with an identifier, such as a rule name or ID number. The decision table also includes one or more input fields and one or more output fields. Each input field may be assigned a priority based on the positions of the input fields in the table, the number of unique variants in each input field, or a combination thereof.

At block 404, the initial list is pruned based on the variant map to generate a reduced list of rules. The variant map describes differences between the plurality of rules in a previous version of the decision table. The previous version of the decision table may have been verified to ensure that the rules are compatible and do not cause conflicts. The variant map may have been generated during a previous instance of the verification process. The variant map may be a cross correlation table, wherein each entry of the cross correlation table indicates a highest priority input field at which a cross correlated pair of rules differ.

The initial list may include all of the rules in the decision table. Pruning the initial list means that rules are eliminated from the list if the variant map indicates that the changed rule and the eliminated rule do not intersect, i.e., the two rules cannot be triggered for the same inputs. For example, pruning the initial list may include determining, for each input field, whether the input field of the changed rule has changed compared to the previous version of the decision table, and if the input field of the changed rule has not changed, eliminating from the initial list of rules those rules for which the variant map indicates a variant on the same input field with respect to the changed rule. This pruning process may be performed for each input field in order of priority from highest priority to lowest priority.

At block 406, a validation process is performed for the reduced list of rules. The validation process tests the decision table to identify possible errors, such as overlapping rules, redundant rules, and other conflicts or defects. The validation process may include any suitable decision table testing process, including a line sweeping algorithm, black box testing, and others. The results of the validation process may be stored and/or displayed to the user.

In some embodiments, the decision table may be compiled into a rule base for a decision engine. For example, the decision table may be compiled into a file, such as a DMN file. The decision table may also be converted to a different format or programming language, i.e., transpiled. For example, the decision table may be stored as an XLS, XML or JSON file and transpiled into Drools source code, which is then compiled to form the rule base for a Drools rule engine. In some embodiments, the decision table may be one of two or more decision tables that are compiled and/or transpiled together to form the rule base.

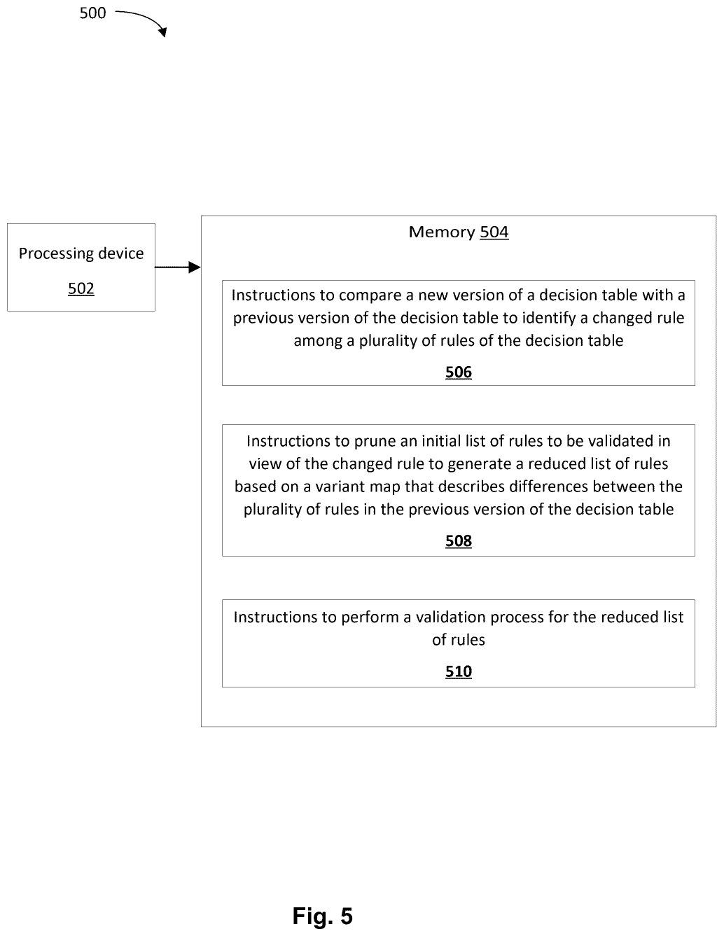

FIG. 5 is a block diagram of a system for validating a decision table, in accordance with some embodiments of the present disclosure. The system 500 includes a processing device 502 operatively coupled to a memory 504. The memory 504 includes instructions that are executable by the processing device 502 to cause the processing device 502 to validate a decision table.

The memory 504 includes instructions 506 to compare a new version of a decision table with a previous version of the decision table to identify a changed rule among a plurality of rules of the decision table. The memory 504 also includes instructions 508 to prune an initial list of rules to be validated in view of the changed rule to generate a reduced list of rules based on a variant map that describes differences between the plurality of rules in the previous version of the decision table. The memory 504 also includes instructions 510 to perform a validation process for the reduced list of rules.

It will be appreciated that various alterations may be made to the process illustrated in FIG. 5 and that some components and processes may be omitted or added without departing from the scope of the disclosure.

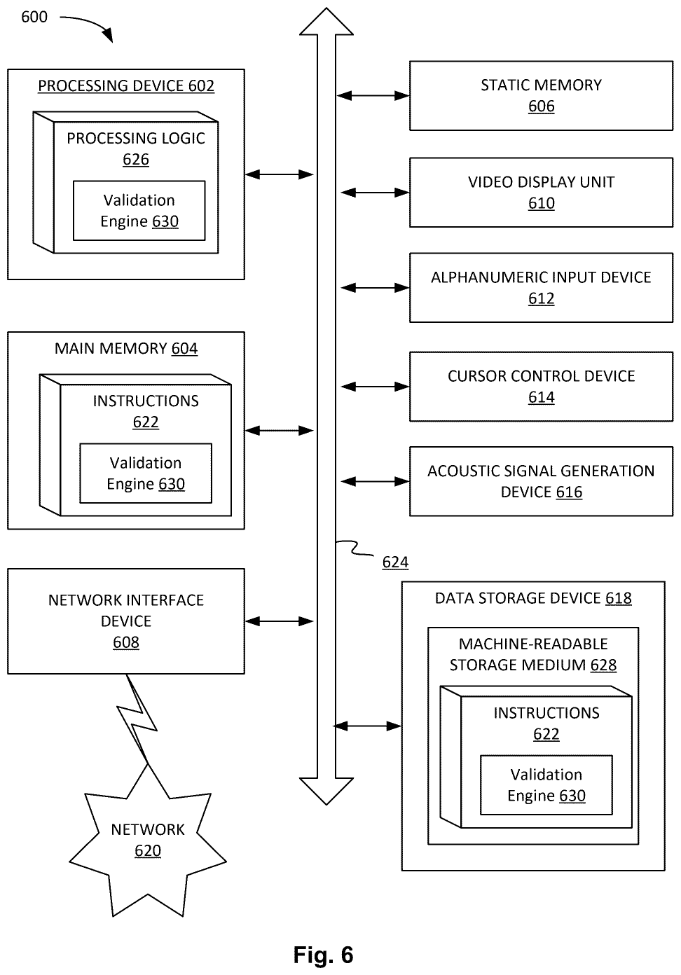

FIG. 6 illustrates a diagrammatic representation of a machine in the example form of a computer system 600 within which a set of instructions, for causing the machine to perform any one or more of the methodologies discussed herein.

In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In some embodiments, computer system 600 may be representative of a server.

The exemplary computer system 600 includes a processing device 602, a main memory 604 (e.g., read-only memory (ROM), flash memory, dynamic random access memory (DRAM), a static memory 606 (e.g., flash memory, static random access memory (SRAM), etc.), and a data storage device 618 which communicate with each other via a bus 624. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Computer system 600 may further include a network interface device 608 which may communicate with a network 620. The computer system 600 also may include a video display unit 610 (e.g., a liquid crystal display (LCD) or a cathode ray tube (CRT)), an alphanumeric input device 612 (e.g., a keyboard), a cursor control device 614 (e.g., a mouse) and an acoustic signal generation device 616 (e.g., a speaker). In some embodiments, video display unit 610, alphanumeric input device 612, and cursor control device 614 may be combined into a single component or device (e.g., an LCD touch screen).

Processing device 602 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 602 may also be one or more special-purpose processing devices such as an application specific integrated circuit (ASIC), a field programmable gate array (FPGA), a digital signal processor (DSP), network processor, or the like. The processing device 602 is configured to execute the validation engine 630, for performing the operations and steps discussed herein.

The data storage device 618 may include a machine-readable storage medium 628, on which is stored one or more instructions 622 (e.g., software) embodying any one or more of the methodologies of functions described herein. For example, the instructions 622 may include a validation engine 630. The instructions 622 may also reside, completely or at least partially, within the main memory 604 or within the processing device 602 during execution thereof by the computer system 600; the main memory 604 and the processing device 602 also constituting machine-readable storage media. The instructions 622 may further be transmitted or received over a network 620 via the network interface device 608.

The machine-readable storage medium 628 may be used to store instructions to perform a method for validating a decision table, as described herein. While the machine-readable storage medium 628 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

Unless specifically stated otherwise, terms such as “receiving,” “sending,” “identifying,” “determining,” “activating,” “eliminating,” “pruning,” “performing,” “generating,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware--for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present disclosure to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the present disclosure is not to be limited to the details given herein, but may be modified within the scope and equivalents of the appended claims.

What is claimed is:

1. A method, comprising:
comparing a new version of a decision table with a previous version of the decision table to identify a changed rule among a plurality of rules of the decision table;
pruning, by a processing device, an initial list of rules to be validated in view of the changed rule to generate a reduced list of rules based on a variant map that describes differences between the plurality of rules in the previous version of the decision table; and
performing a validation process for the reduced list of rules.

2. The method of claim 1, wherein the variant map comprises a cross correlation table, wherein each entry of the cross correlation table indicates a highest priority input field at which a cross correlated pair of rules differ.

3. The method of claim 1, further comprising generating a new variant map to be used for a subsequent validation of the decision table.

4. The method of claim 1, further comprising assigning a priority to each input field of the decision table based on a number of unique variants in each input field.

5. The method of claim 1, wherein pruning the initial list comprises:
identifying a highest priority input field;
determining whether the highest priority input field of the changed rule has changed compared to the previous version of the decision table; and
in response to determining that the highest priority input field of the changed rule has not changed, eliminating from the initial list of rules those rules for which the variant map indicates a variant on the highest priority input field with respect to the changed rule.

6. The method of claim 5, wherein pruning the initial list further comprises:
identifying a next highest priority input field;
determining whether the next highest priority input field of the changed rule has changed compared to the previous version of the decision table; and
in response to determining that the next highest priority input field of the changed rule has not changed, eliminating from the initial list of rules those rules for which the variant map indicates a variant on the next highest priority input field with respect to the changed rule.

7. The method of claim 1, further comprising compiling the decision table to generate a file to be used for a rules engine.

8. A system comprising:
a memory; and
a processing device operatively coupled to the memory, the processing device to:
compare a new version of a decision table with a previous version of the decision table to identify a changed rule among a plurality of rules of the decision table;
prune an initial list of rules to be validated in view of the changed rule to generate a reduced list of rules based on a variant map that describes differences between the plurality of rules in the previous version of the decision table; and
perform a validation process for the reduced list of rules.

9. The system of claim 8, wherein the variant map comprises a cross correlation table, wherein each entry of the cross correlation table indicates a highest priority input field at which a cross correlated pair of rules differ.

10. The system of claim 8, wherein the processing device is further to generate a new variant map to be used for a subsequent validation of the decision table.

11. The system of claim 8, wherein the processing device is further to assign a priority to each input field of the decision table based on a number of unique variants in each input field.

12. The system of claim 8, wherein the to prune the initial list, the processing device is to:
identify a highest priority input field;
determine whether the highest priority input field of the changed rule has changed compared to the previous version of the decision table; and
in response to a determination that the highest priority input field of the changed rule has not changed, eliminate from the initial list of rules those rules for which the variant map indicates a variant on the highest priority input field with respect to the changed rule.

13. The system of claim 12, wherein to prune the initial list, the processing device is to:
identify a next highest priority input field;
determine whether the next highest priority input field of the changed rule has changed compared to the previous version of the decision table; and
in response to a determination that the next highest priority input field of the changed rule has not changed, eliminate from the initial list of rules those rules for which the variant map indicates a variant on the next highest priority input field with respect to the changed rule.

14. The system of claim 8, wherein the processing device is further to compile the decision table to generate a file to be used for a rules engine.

15. A non-transitory computer readable medium, comprising instructions stored thereon which, when executed by a processing device, cause the processing device to:
compare a new version of a decision table with a previous version of the decision table to identify a changed rule among a plurality of rules of the decision table;
prune, by the processing device, an initial list of rules to be validated in view of the changed rule to generate a reduced list of rules based on a variant map that describes differences between the plurality of rules in the previous version of the decision table; and
perform a validation process for the reduced list of rules.

16. The non-transitory computer readable medium of claim 15, wherein the variant map comprises a cross correlation table, wherein each entry of the cross correlation table indicates a highest priority input field at which a cross correlated pair of rules differ.

17. The non-transitory computer readable medium of claim 15, further comprising instructions that cause the processing device to generate a new variant map to be used for a subsequent validation of the decision table.

18. The non-transitory computer readable medium of claim 15, further comprising instructions that cause the processing device to assign a priority to each input field of the decision table based on a number of unique variants in each input field.

19. The non-transitory computer readable medium of claim 15, wherein the instructions to cause the processing device to prune the initial list, cause the processing device to:
identify a highest priority input field;
determine whether the highest priority input field of the changed rule has changed compared to the previous version of the decision table; and
in response to a determination that the highest priority input field of the changed rule has not changed, eliminate from the initial list of rules those rules for which the variant map indicates a variant on the highest priority input field with respect to the changed rule.

20. The non-transitory computer readable medium of claim 19, wherein the instructions to cause the processing device to prune the initial list, cause the processing device to:
identify a next highest priority input field;
determine whether the next highest priority input field of the changed rule has changed compared to the previous version of the decision table; and
in response to a determination that the next highest priority input field of the changed rule has not changed, eliminate from the initial list of rules those rules for which the variant map indicates a variant on the next highest priority input field with respect to the changed rule.
